(19) United States
(12) Patent Application Publication
(10) Pub. No.: US 2005/0138051 A1
(43) Pub. Date: Jun. 23, 2005

(54) Method for processing Electronic Data Interchange (EDI) data from multiple customers

(76) Inventor: Michael J. Gardner, Findlay, OH (US)

Correspondence Address: HARNESS, DICKEY & PIERCE, P.L.C., P.O. BOX 828, BLOOMFIELD HILLS, MI, 48303, US

(21) Appl. No.: 10/742,676

(22) Filed: Dec. 19, 2003

(51) Int. Cl. G06F 17/00

(52) U.S. Cl. 707/101

(57) ABSTRACT

An information processing system for processing Electronic Data Interchange (EDI) data is disclosed. Customer data is received in EDI format is converted into a database format by a set of PERL language scripts by selecting a particular PERL script or module that corresponds to the type of EDI data received. The converted data is stored in databases to be used by operations control systems such as a plant production control system.

### FIELD OF THE INVENTION

The present invention relates to electronic data processing and more particularly to Electronic Data Interchange (EDI) based information processing.

### BACKGROUND OF THE INVENTION

Computer networks having different architectures are found across various business data-processing environments. Some business networks use proprietary network protocols and data-storage formats that need to be converted into other forms if the data from such networks are to be used by other networks that cannot interpret proprietary formats. Although non-proprietary network protocols like the TCP/IP have emerged as an effective bridge between incompatible local networks, the formats in which data is stored and structured on a network remain non-homogenous and proprietary to a large extent. Hence, there arose a need for a common standardized data format for information exchange in business environments. The EDI family of data-formats is an attempt in this direction. EDI and its applications are considered next.

EDI allows data to be stored and transmitted over networks in standardized formats that can be interpreted by the receiving computer system. The receiving computer must have a software application that can interpret and process the incoming EDI formatted data. Business data-processing is typically carried out using database systems, and in particular by relational database systems. Typically, a set of applications running on the receiving computer system is required to process data received from customers in multiple formats. However, such a set of applications is complex to maintain. Further, the whole production control software system becomes difficult to maintain when either a monolithic EDI-to-database conversion application is used or a set of diverse modules for EDI-to-database conversion are used.

### SUMMARY OF THE INVENTION

A method information processing where the received data is in EDI format is described. The received EDI formatted data is converted by a set of PERL scripts or modules into a database format, typically relational database format. The process of selecting a particular PERL script for a particular type of EDI data is automatic and does not require user-intervention. The PERL scripts and the EDI data-type that it can convert is stored in an indexed array which is typically a PERL hash. The converted data can be used for a variety of purposes. For example, a plant control system is described that is automatically controlled by the customers. The customers sends requirements in EDI format and the PERL scripts convert that EDI formatted data into databases, which is then used to schedule production and also increase production if required.

### BRIEF DESCRIPTION OF THE DRAWINGS

The present invention will become more fully understood from the detailed description and the accompanying drawings, wherein:

FIG.1 is a block-diagram of a plant management system that employs a PERL (Practical Extraction and Report Language) based EDI-to-database converter;

FIG. 2A is a PERL script snippet that shows splitting of a scalar storing a record;

FIG. 2B is a PERL script snippet that shows separation of a record into fields stored as array elements;

FIG. 2C is a PERL snippet that shows a subroutine call that is based on the type of data in the array; and

FIG. 3 is a flow diagram of the data flow in the EDI data-processing system.

### DETAILED DESCRIPTION OF THE PREFERRED EMBODIMENTS

The following description of the preferred embodiment(s) is merely exemplary in nature and is in no way intended to limit the invention, its application, or uses.

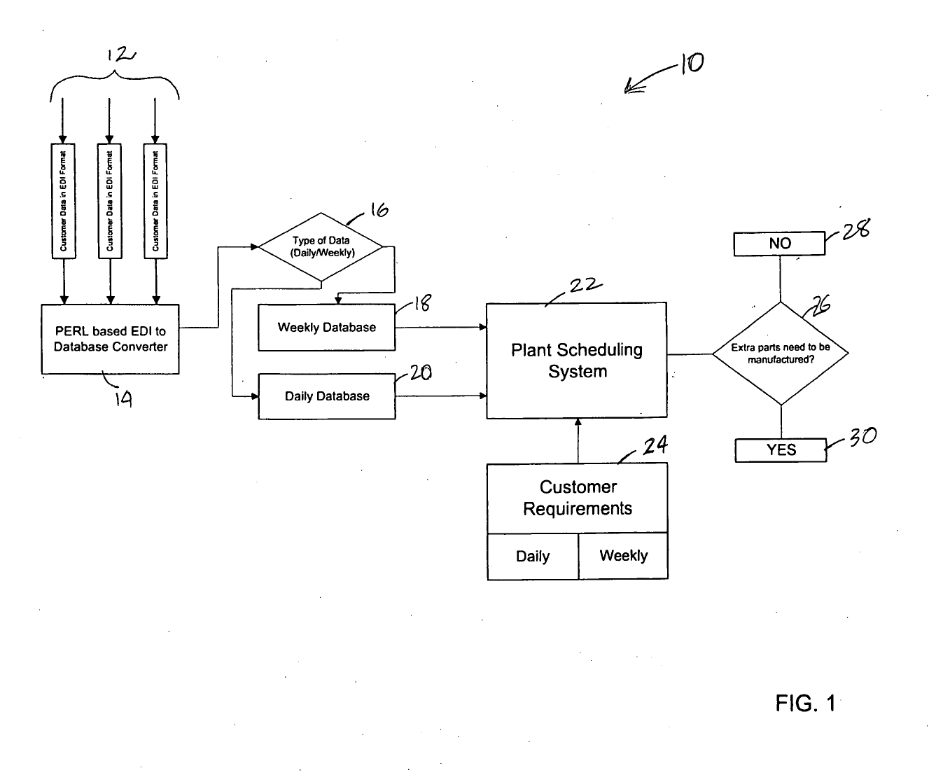

Referring to FIG. 1, a plant management system 10 incorporating the present invention is shown. The plant management system 10 receives input from multiple customers. The customers send their on-going requirements to the producer/manufacturer as EDI data 12 that is received as an input by the system 10. The EDI data 12 is converted into a database format by the PERL based EDI to database converter 14. The converted data is analyzed at data type analyzer 16 as being either weekly data or daily data. The weekly data is stored in the weekly database 18, while the daily data is stored in the daily database 20. Those skilled in the art will appreciate that the converter 14 can be either a single PERL script or a set of distinct PERL modules or scripts.

Data from both the databases, i.e., the weekly database 18 and the daily database 20, are fed into the plant scheduling system 22. The system 10 is designed to be flexible in accepting extra orders from the customers that are over and above the regular orders sent as the EDI data 12 as described above. The additional customer requirements 24 can be scheduled as either daily or weekly orders and are fed into the plan scheduling system 22 to be blended with the data sourced from the weekly database 18 and the daily database 20. The plant scheduling system 22 then uses such blended data to determine if extra parts need to be produced in the next production schedule. Those skilled in the art will appreciate that though the above example uses plant scheduling for an exemplary parts manufacturing operation, the teachings of the present invention may be applied to any type of production or service activity that requires periodic inputs and produces corresponding output.

The formats of the weekly database 18 and the daily database 20 can be relational type. However, other formats like hierarchical, object oriented, XML or a newer format can also be easily incorporated with the present invention by building an appropriate PERL script to convert the EDI data into a new database format and including the same within the hash of conversion processes described below. Those skilled in the art will appreciate that the particular database format used does not limit the invention, and the relational type is used in this description only as an example.

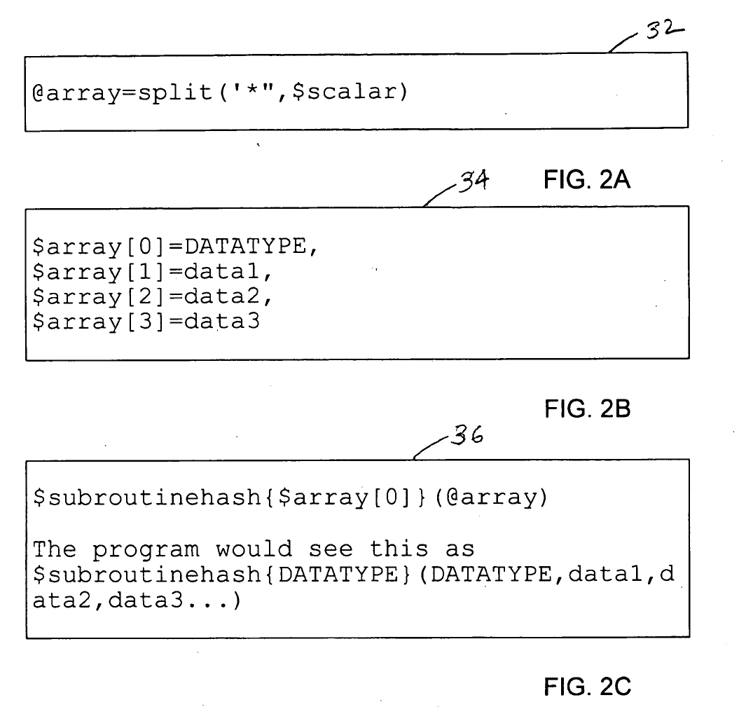

FIG. 2A is a PERL script snippet that shows snippet for a scalar that stores a record; FIG. 2B is a PERL script snippet that shows separation of a record into fields stored as array elements; and FIG. 2C is a PERL snippet that shows a subroutine call that is based on the type of data in the array. The EDI data 12 received from the customer can be formatted in a variety of ways. While the receiving computer of the system 10 will be able to handle only known data-types, it will not be necessary for the customer's sending computer to inform the system 10 each time about the details of the data-type being transmitted. The system 10 receives the EDI data 12 as variable length records using predefined delimiters. The structure of the EDI data 12 record is described next.

The first field in each EDI data 12 record identifies the type of data contained in it. For example, the string “DATATYPE*data1*data2*data3 . . . ” represents the general structure of EDI data 12 record, in which the first field is the data-type indicator and subsequent data-fields are separated using the predetermined delimiter “*”. Those skilled in the art will recognize that the EDI data 12 record may have any type of data-record having fields separated with any form of delimiter (or delimiters), and that the above examples of data-fields and delimiters are merely illustrative in nature.

The system 10 reads a delimited record from the received EDI data 12 and splits the individual fields into a character array as shown in code-snippet 32 (FIG. 2A). The split string in the “array” is stored as the DATATYPE indicator at element [0] and data-elements in the fields [1],[2] and so forth as shown in the snippet 34 (FIG. 2B). Calling of a sub-routine to process the data-fields depending upon the DATATYPE is described next.

A subroutine-hash, i.e., a PERL character indexed array, of subroutines is pre-built to process each separate data-type by a corresponding subroutine. The sub-routine has will typically be composed of multiple key-value pairs, where the key being EDI data-type (format) to be processed and value being a pointer or a link to the corresponding PERL script that can process that particular EDI data-type. Referring to FIG. 2C, the subroutine call is shown at snippet 36, where the first parameter passed is the DATATYPE of the EDI data 12 record and other parameters are the field values. The particular sub-routine to be called is automatically selected based on the value/contents of the DATATYPE stored in the ‘array[0]’ location.

The automatic selection of a particular subroutine through a subroutine hash eliminates the need to have lengthy code for calling a particular sub-routine, based on the data-type, and passing to the sub-routine any specific parameters. On the contrary, due to the use of a subroutine hash the subroutine call has a uniform format as shown in snippet 36. Hence, this technique facilitates seamless and easy conversion of various EDI data 12 formats without any need for human intervention or lengthy and cumbersome coding to handle each EDI data-type with a separate section of code.

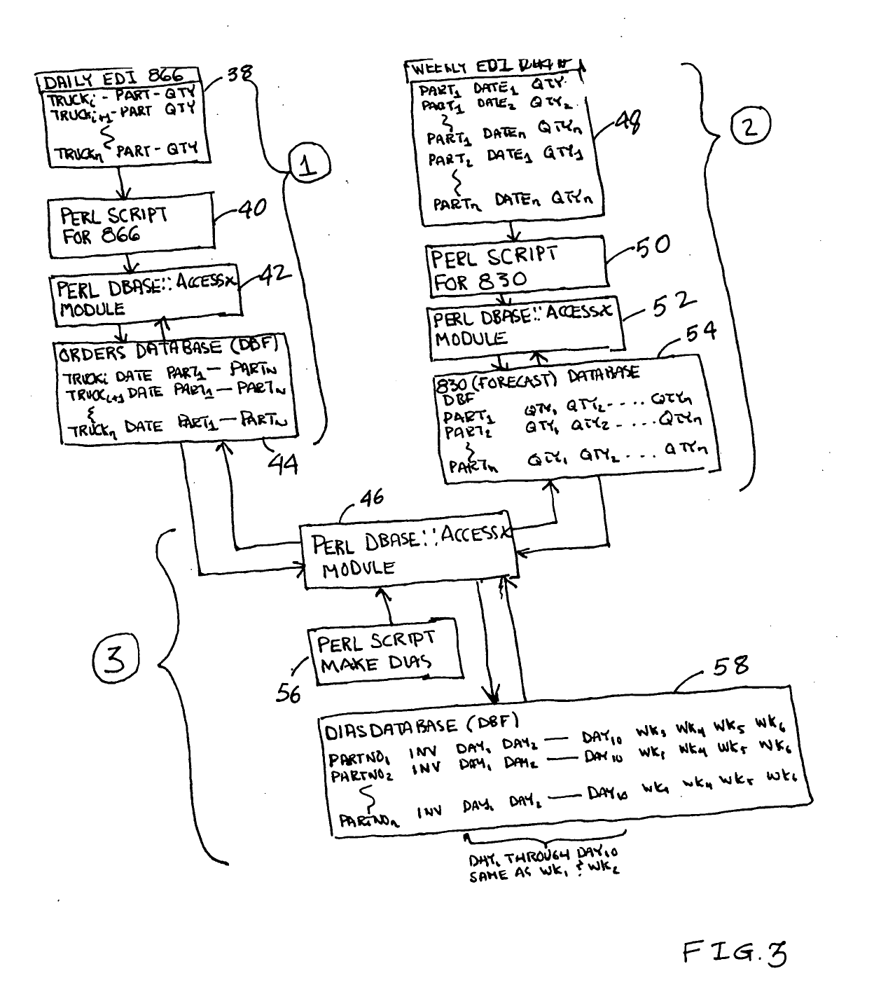

FIG. 3 is a flow diagram of the data-flow in the EDI data-processing system 10. An example of the operation of the whole system in the context of a production planning system for an automobile part manufacturer is described next. The daily EDI data 12 is received from customers, which in this example are truck parts as shown at step 38. A particular PERL script is selected to convert the received daily EDI data 12 as shown at step 40 depending upon the type of the data as described above. The PERL DBASE::AccessX module at step 42 converts the EDI data 12 processed by the selected PERL script into a database record and stores it in the daily database 20 (see FIG. 1). In a similar manner, weekly EDI data 12 is sourced at step 48, converted by an automatically selected PERL script at step 50, and converted into a weekly database 18 record format at step 54.

The integration of daily and weekly data is described next. The PERL DBASE:AccessX module at step 46 collects data from the daily database 20 and the weekly database 18 to create a production control database shown at step 58. This particular module uses PERL scripts as shown at step 56 to create the production control database. The integration of the daily data is performed by filtering the daily database 20 and the weekly database 18. In the context of FIG. 1 the above operations are carried out by the plant scheduling system 22 that determines (decision step 26) if extra parts are to be manufactured (step 30) or not (step 28).

The system 10 achieves the conversion of EDI data 12 into a database format that can be easily filtered and processed. One application of such EDI-to-database conversion as described above is to control a production planning system. However, those skilled in the art will recognize that a production planning system is just an illustrative application of the present invention, and this example not meant to be limiting in any manner. The present invention provides seamless conversion of EDI data into database formats without any need for human intervention. Further, PERL based scripting is applied to select a particular module for converting the specific type of EDI data received from the customers. Hence, EDI data from multiple customers in differing formats can be processed by the system without any separate code required to determine which particular converter needs to be selected.

The description of the invention is merely exemplary in nature and, thus, variations that do not depart from the gist of the invention are intended to be within the scope of the invention. Such variations are not to be regarded as a departure from the spirit and scope of the invention.

1. An information processing system for processing Electronic Data Interchange (EDI) data, the system comprising:
a data-converter operating on a first computer, said data converter receiving customer data from at least one customer computer in at least one EDI format;
a plurality of conversion processes for converting the customer data received in said at least one EDI format into a database format;
an indexed array including pairs, said pairs including a given EDI format of said at least one EDI format and a link to a given conversion processes of the plurality of conversion processes that can process the given EDI format; and
wherein said data-converter automatically selects the given one of said plurality of conversion processes corresponding to the given one of said at least one EDI format from said indexed array and said data-converter converts the customer data in said EDI format in to said database format.

2. The information system of claim 1, wherein said plurality of conversion processes are PERL language scripts, and wherein said data converter selects a given PERL script for converting the customer data in said EDI format into said database format.

3. The information system of claim 1, wherein said indexed array is a hash.

4. The information system of claim 1, further comprising:
a database storage module, said database storage module being part of said data-converter and operative for storing said converted customer data in said database format into a database.

5. The information system of claim 1, wherein said database format is a relational format and said database is a relational database.

6. An information management system for processing customer data received in EDI formats, the system comprising:
a data-converter operating on a first computer, said data converter receiving customer data from at least one customer computer in at least one EDI format;
a plurality of conversion processes for converting the customer data received in said at least one EDI format into a database format;
said data-converter converting said customer data in said EDI format to said database format using said conversion processes and storing the converted said customer data into an operations database; and
an operations scheduler for controlling the operations of an organization, said operations scheduler utilizing the customer data stored in said operations database to schedule the operations for the organization.

7. The system of claim 6, wherein said operations database stores data regarding production, said operations scheduler being a production scheduler, and said organization being a manufacturing organization.

8. The system of claim 6, further comprising:
an additional customer requirement input to said operations database to increase operations for a given customer.

9. The system of claim 6, wherein said operations database comprising:
a daily orders database; and
a weekly orders database, said daily order database and said weekly orders database being automatically updated by said data-converter.

10. The system of claim 6, wherein said database format being a relational database and said operations database being a relational database.

11. A method for processing EDI data received from multiple customers, the method comprising:
receiving customer data in an EDI format;
using a set of conversion processes to convert the customer data in said EDI format to a database format; and
storing the converted customer data in said database format in a database.

12. The method of claim 11, where said conversion processes are PERL scripts.

13. The method of claim 11, further comprising:
building an indexed array including pairs of said EDI format and a given said conversion processes that can process said EDI format; and
automatically selecting a given one of said conversion processes corresponding to a given said EDI format from said indexed array; and
converting the customer data in said EDI format in to said database format.
